(19) United States
(12) Patent Application Publication
(10) Pub. No.: US 2022/0414328 A1
(43) Pub. Date: Dec. 29, 2022

(54) METHOD AND SYSTEM FOR PREDICTING FIELD VALUE USING INFORMATION EXTRACTED FROM A DOCUMENT

(71) Applicant: SERVICENOW CANADA INC., Montreal (CA)

(72) Inventors: Olivier NGUYEN, Montreal (CA); Nitin SURYA, Montreal (CA)

(73) Assignee: SERVICENOW CANADA INC., Montreal (CA)

(21) Appl. No.: 17/304,583

(22) Filed: Jun. 23, 2021

(51) Int. Cl. G06F 40/279; G06F 40/174; G06K 9/00; G06K 9/62

(52) U.S. Cl. CPC G06F 40/279; G06F 40/174; G06K 9/00463; G06K 9/00456; G06K 9/623; G06K 2209/01

(57) ABSTRACT

There is provided a method and a system for recommending a given text candidate as a value for a field. A document image is received and a set of text boxes are detected using optical character recognition, each of the set of text boxes comprising a respective character sequence. For each text box, based on at least the respective character sequence, at least one respective text candidate is generated to thereby obtain a set of text candidates. At least one feature extractor is used to generate a respective candidate feature vector based on each respective text candidate. An indication of the field is received, and a respective candidate score indicative of a relevance of the respective text candidate is determined. In response to a given candidate score being above a threshold, the given text candidate associated with the given candidate score is output as a recommendation for the field.

### CROSS-REFERENCE TO RELATED APPLICATIONS

None

### FIELD

The present technology relates to machine learning (ML) in general and more specifically to methods and systems for predicting values for fields using information extracted from a document by an optical character recognition (OCR) model.

### BACKGROUND

At least some of the systems for extracting information from a document rely either upon templates or large amounts of labelled training data. In the former case, the resulting systems are rigid and require intensive maintenance. In the latter, labelled data is difficult and expensive to acquire, often necessitating manual labelling.

Therefore, there is a need for an improved method and system for predicting field values using extracting information extracted from a document.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

In accordance with a broad aspect of the present technology, there is provided a method for recommending a given text candidate as a value for a field, the method is executed by a processor. The method comprises: receiving a document image, detecting, using an optical character recognition (OCR) model, a set of text boxes from the document image, each text box of the set of text boxes comprises a respective character sequence, generating, for each text box in the set of text boxes, based on at least the respective character sequence, at least one respective text candidate to thereby obtain a set of text candidates, generating, using at least one feature extractor, based on each respective text candidate, a respective candidate feature vector being indicative of at least text features of the respective text candidate, receiving an indication of the field, determining, using a classifier, a respective candidate score for each respective text candidate of the set of text candidates, the respective candidate score being indicative of a relevance of the respective text candidate as a value for the field, and in response to a given candidate score being above a threshold: outputting the given text candidate associated with the given candidate score as a recommendation for the field.

In one or more embodiments of the method, the method further comprises, after said determining the respective candidate score: determining, using a confidence model, a respective confidence score being indicative of a probability of the given text candidate being an exact match for the field, and said outputting the given text candidate associated with the given candidate score as the recommendation for the field is further based on the respective confidence score being above a confidence threshold.

In one or more embodiments of the method, the confidence threshold is a first confidence threshold, and in response to the given candidate score being above a second confidence threshold, the method further comprises filing the field with the given text candidate.

In one or more embodiments of the method, the processor is connected to a client device, said receiving the indication of the field is received from the client device, said outputting the given text candidate associated with the given candidate score as the recommendation for the field comprises transmitting, for display on a display interface of the client device, the given text candidate.

In one or more embodiments of the method, each text box of the set of text boxes is associated with a respective bounding box indicative of a location of the text box in the document image, said generating, for each text box in the set of text boxes, at least one respective text candidate to thereby obtain a set of text candidates is further based on the respective bounding box.

In one or more embodiments of the method, said receiving the indication of the field comprises receiving an indication of at least one character typed by a user for the field.

In one or more embodiments of the method, the at least one feature extractor comprises a plurality of feature extractors, and said generating the candidate feature vector for the respective text candidate comprises generating, using the plurality of feature extractors, a respective set of feature vectors and combining the respective feature vectors to obtain the candidate feature vector.

In one or more embodiments of the method, said receiving the indication of the field is performed prior to said generating, using the at least one feature extractor, based on each respective text candidate, the respective candidate feature vector, and said generating, using the at least one feature extractor, based on each respective text candidate, the respective candidate feature vector is further based on the indication of the field.

In one or more embodiments of the method, the candidate feature vector comprises at least one of: string statistics of the text candidate, an indication if the text candidate matches a given predetermined regular expression (REGEX), an indication if the text candidate has been previously used for a given field, an indication of a probability given past candidates for a given field for the given text candidate to be part of the value of the field.

In one or more embodiments of the method, said generating the text candidate comprises: splitting the given text box into a set of words, and generating n-grams from the set of words to thereby obtain the text candidate.

In one or more embodiments of the method, in response to none of the respective candidate scores being above the threshold: transmitting an indication to label the field, receiving the label for the field, and training the classifier based on the field and the label for the field.

In one or more embodiments of the method, the classifier comprises a random forest model.

In accordance with a broad aspect of the present technology, there is provided a system for recommending a given text candidate as a value for a field. The system comprises: a processor, and a non-transitory storage medium operatively connected to the processor, the non-transitory storage medium comprising instructions. The processor, upon executing the instructions, is configured for: receiving a document image, detecting, using an optical character recognition (OCR) model, a set of text boxes from the document image, each text box of the set of text boxes comprises a respective character sequence, generating, for each text box in the set of text boxes, based on at least the respective character sequence, at least one respective text candidate to thereby obtain a set of text candidates, generating, using at least one feature extractor, based on each respective text candidate, a respective candidate feature vector being indicative of at least text features of the respective text candidate, receiving an indication of the field, determining, using a classifier, a respective candidate score for each respective text candidate of the set of text candidates, the respective candidate score being indicative of a relevance of the respective text candidate as a value for the field, and in response to a given candidate score being above a threshold: outputting the given text candidate associated with the given candidate score as a recommendation for the field.

In one or more embodiments of the system, the processor is further configured for, after said determining the respective candidate score: determining, using a confidence model, a respective confidence score being indicative of a probability of the given text candidate being an exact match for the field, and said outputting the given text candidate associated with the given candidate score as the recommendation for the field is further based on the respective confidence score being above a confidence threshold.

In one or more embodiments of the system, the confidence threshold is a first confidence threshold, and the processor is further configured for, in response to the given candidate score being above a second confidence threshold: filing the field with the given text candidate.

In one or more embodiments of the system, the processor is connected to a client device, said receiving the indication of the field is received from the client device, said outputting the given text candidate associated with the given candidate score as the recommendation for the field comprises transmitting, for display on a display interface of the client device, the given text candidate.

In one or more embodiments of the system, each text box of the set of text boxes is associated with a respective bounding box indicative of a location of the text box in the document image, said generating, for each text box in the set of text boxes, at least one respective text candidate to thereby obtain a set of text candidates is further based on the respective bounding box.

In one or more embodiments of the system, said receiving the indication of the field comprises receiving an indication of at least one character typed by a user for the field.

In one or more embodiments of the system, the at least one feature extractor comprises a plurality of feature extractors, and said generating the candidate feature vector for the respective text candidate comprises generating, using the plurality of feature extractors, a respective set of feature vectors and combining the respective feature vectors to obtain the candidate feature vector.

In one or more embodiments of the system, said receiving the indication of the field is performed prior to said generating, using the at least one feature extractor, based on each respective text candidate, the respective candidate feature vector, and said generating, using the at least one feature extractor, based on each respective text candidate, the respective candidate feature vector is further based on the indication of the field.

In one or more embodiments of the system, the candidate feature vector comprises at least one of: string statistics of the text candidate, an indication if the text candidate matches a given predetermined regular expression (REGEX), an indication if the text candidate has been previously used for a given field, an indication of a probability given past candidates for a given field for the given text candidate to be part of the value of the field.

In one or more embodiments of the system, said generating the text candidate comprises: splitting the given text box into a set of words, and generating n-grams from the set of words to thereby obtain the text candidate.

In one or more embodiments of the system, in response to none of the respective candidate scores being above the threshold: transmitting an indication to label the field, receiving the label for the field, and training the classifier based on the field and the label for the field.

In one or more embodiments of the system, the classifier comprises a random forest model.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting embodiments of the present technology.

FIG. 2 depicts a schematic diagram of a system in accordance with one or more non-limiting embodiments of the present technology.

FIG. 3 depicts a high level schematic diagram of a text detection and recommendation procedure in accordance with one or more non-limiting embodiments of the present technology.

FIG. 4 depicts a schematic diagram of an autocompletion procedure implemented in accordance with one or more non-limiting embodiments of the present technology.

FIG. 5 depicts a schematic diagram of four different phases of the autocompletion procedure of FIG. 4 implemented in accordance with one or more non-limiting embodiments of the present technology.

FIG. 6 depicts a flow chart of a method for predicting a value for a given field in a document after performing optical character recognition (OCR) in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

Electronic Device

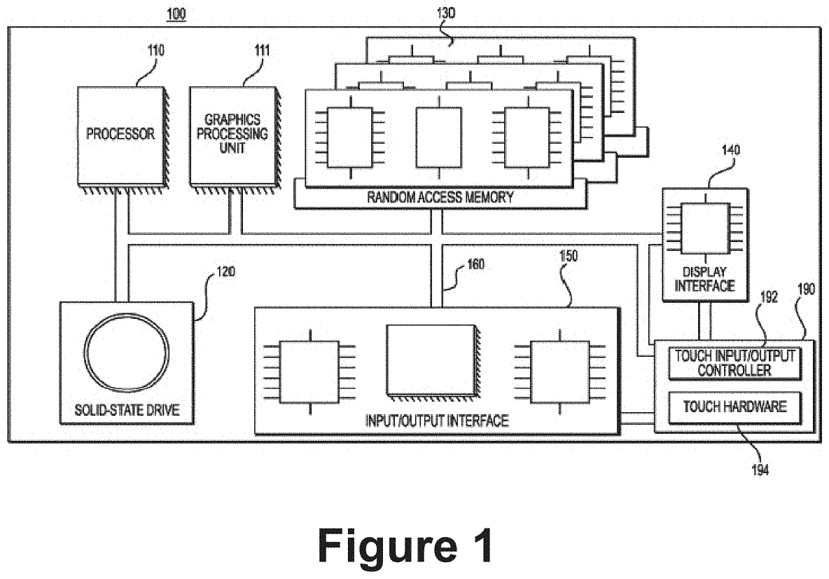

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111. For example, the program instructions may be part of a library or an application.

The electronic device 100 may be implemented as a server, a desktop computer, a laptop computer, a tablet, a smartphone, a personal digital assistant or any device that may be configured to implement the present technology, as it may be understood by a person skilled in the art.

System

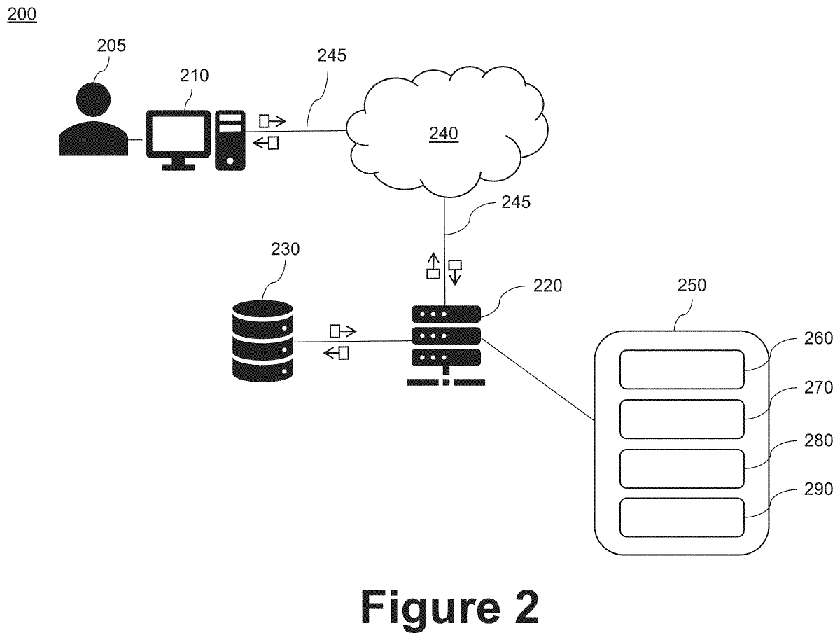

Referring to FIG. 2, there is shown a schematic diagram of a system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a client device 210 associated with a user 205, a server 220, and a database 230 communicatively coupled over a communications network 240.

Client Device

The system 200 comprises a client device 210. The client device 210 is associated with the user 205. As such, the client device 210 can sometimes be referred to as a “electronic device”, “end user device” or “client electronic device”. It should be noted that the fact that the client device 210 is associated with the user 205 does not need to suggest or imply any mode of operation—such as a need to log in, a need to be registered, or the like.

The client device 210 comprises one or more components of the electronic device 100 such as one or more single or multi-core processors collectively represented by processor 110, the graphics processing unit (GPU) 111, the solid-state drive 120, the random-access memory 130, the display interface 140, and the input/output interface 150.

In one or more embodiments, the user 205 may be an assessor. The user 205 may be part of a “human in the loop (HITL)” process to label data which is used to continuously train machine learning models to perform predictions. The user 205 may for example confirm that predictions made by models are accurate, flag predictions that are incorrect and provide corrected labels to predictions.

It will be appreciated that while only one client device 210 and user 205 are depicted, there may be a plurality of client devices with associated users without departing from the scope of the present technology.

Server

The server 220 is configured to inter alia: (i) access and continuously train a set of machine learning (ML) models 250; (ii) receive document images; (iii) detect, using optical character recognition (OCR) models, text boxes in the document images; (iv) generate a set of text candidates using the text boxes; (v) generate, based on the set of text candidates, a set of feature vectors; (vi) receive an indication of a field; (vii) determine, based on the set of feature vectors, respective candidate scores for the text boxes; (viii) in response to a candidate score associated with a given candidate being above a threshold, recommending the given candidate for the field; and (ix) receive indications of labels and predictions from the client device 210.

How the server 220 is configured to do so will be explained in more detail herein below.

It will be appreciated that the server 220 can be implemented as a conventional computer server and may comprise at least some of the features of the electronic device 100 shown in FIG. 1. In a non-limiting example of one or more embodiments of the present technology, the server 220 is implemented as a server running an operating system (OS). Needless to say that the server 220 may be implemented in any suitable hardware and/or software and/or firmware or a combination thereof. In the disclosed non-limiting embodiment of present technology, the server 220 is a single server. In one or more alternative non-limiting embodiments of the present technology, the functionality of the server 220 may be distributed and may be implemented via multiple servers (not shown).

The implementation of the server 220 is well known to the person skilled in the art. However, the server 220 comprises a communication interface (not shown) configured to communicate with various entities (such as the database 230, for example and other devices potentially coupled to the communication network 240) via the communication network 240. The server 220 further comprises at least one computer processor (e.g., the processor 110 of the electronic device 100) operationally connected with the communication interface and structured and configured to execute various processes to be described herein.

Machine Learning (ML) Models

In one or more embodiments, the set of ML models 250 comprises inter alia a set of OCR models 260, a set of feature extractors 270, a set of classification ML models 280, and a set of regression ML models 290.

It will be appreciated that each of the set of OCR models 260, the set of feature extractors 270, the set of classification ML models 280 and the set of regression ML models 290 may each comprise one or more models (i.e. at least one model).

The set of OCR models 260 comprise one or more models used for performing optical character recognition (OCR) by receiving an image as an input and by outputting recognized text in the image. The recognized text may be for example associated with a respective location and area in the image in the form of a bounding box. In one or more other embodiments, the set of OCR models 260 may not be directly executed by the server 220.

The set of feature extractors 270 are configured to extract text features from character and text sequences. The set of features extracted by the set of feature extractors 270 for a given object generally comprise a plurality of features, which may be represented in the form of a feature vector.

It will be appreciated that the feature extractors may extract features from set of characters, words, sentences, paragraphs, documents or a combination thereof, as will be explained in more detail herein below.

The set of classification ML models 280 comprises one or more classification ML models, also known as classifiers, including models that attempt to estimate the mapping function (f) from the input variables (x) to one or more discrete or categorical output variables (y). The set of classification ML models 280 may include linear and/or non-linear classification ML models.

In the context of the present technology, at least a portion the set of classification ML models 280 are configured to classify character and text sequences into one or more classes. Additionally, each classification may be associated with a classification score for the class. In one or more embodiments, the set of classification ML models 280 use features extracted by one or more of the set of feature extractors.

The set of classification ML models 280 may also comprise classification ML models

Non-limiting examples of classification ML models include: Perceptrons, Naive Bayes, Decision Tree, Logistic Regression, K-Nearest Neighbors, Artificial Neural Networks (ANN)/Deep Learning (DL), Support Vector Machines (SVM), and ensemble methods such as Random Forest, Bagging, AdaBoost, and the like.

The set of regression ML models 290 comprises one or more regression ML including ML models that attempt to estimate the mapping function (f) from the input variables (x) to numerical or continuous output variables (y).

In one or more embodiments, the set of regression ML models 290 comprise ML models to determine a confidence score of the predictions performed by other ML models such as the set of feature extractors 270 and the other classification ML models 280.

Non-limiting examples of regression ML models include: Linear Regression, Ordinary Least Squares Regression (OLSR), Stepwise Regression, Multivariate Adaptive Regression Splines (MARS), Locally Estimated Scatterplot Smoothing (LOESS), and Logistic Regression.

In one or more embodiments, the server 220 may execute one or more of the set of ML models 250. In one or more alternative embodiments, one or more of the set of ML models 250 may be executed by another server (not depicted), and the server 220 may access the one or more of the set of ML models 250 for training or for use by connecting to the server (not shown) via an API (not depicted), and specify parameters of the one or more of the set of ML models 250, transmit data to and/or receive data from the ML models 250, without directly executing the one or more of the set of ML models 250.

As a non-limiting example, one or more ML models of the set of ML models 250 may be hosted on a cloud service providing a machine learning API.

Database

A database 230 is communicatively coupled to the server 220 and the client device 210 via the communications network 240 but, in one or more alternative implementations, the database 230 may be communicatively coupled to the server 220 without departing from the teachings of the present technology. Although the database 230 is illustrated schematically herein as a single entity, it will be appreciated that the database 230 may be configured in a distributed manner, for example, the database 230 may have different components, each component being configured for a particular kind of retrieval therefrom or storage therein.

The database 230 may be a structured collection of data, irrespective of its particular structure or the computer hardware on which data is stored, implemented or otherwise rendered available for use. The database 230 may reside on the same hardware as a process that stores or makes use of the information stored in the database 230 or it may reside on separate hardware, such as on the server 220. The database 230 may receive data from the server 220 for storage thereof and may provide stored data to the server 220 for use thereof.

In one or more embodiments of the present technology, the database 230 is configured to store inter alia: (i) document images; (ii) recognized document images comprising text boxes; (iii) tasks, fields and templates for document images and their definition; and (iv) training parameters and hyperparameters of the set of ML models 250.

A given document image comprises a digital representation of a structured document, i.e. a document including sequences of characters disposed in a relatively organized manner. A given document image may comprise one or more pages. It will be appreciated that the image may have been scanned, may have been photographed, or may have been computer generated to be represented in a digital format. It should be noted that the one or more images may be represented in a variety of digital formats such as, but not limited to EXIF, TIFF, GIF, JPEG, PDF and the like.

In one or more embodiments, text and characters included in the document image may be divided in sections, may be organized in hierarchies, may include lists, tables, paragraphs, flow charts, and/or fields. As a non-limiting example, the document image may comprise at least a portion of a receipt, an application form, a report, an official record, an identity card, and the like.

A recognized document image comprises text detected and extracted from a document image. In one or more embodiments, the text detected and extracted from the document image is provided by one or more of the set of OCR models 260 in the form of text boxes which include detected text and their respective bounding boxes indicative of their location in the document image.

It will be appreciated that the recognized document image may include the original document image with the recognized text overlayed thereon, or may only include the recognized text associated with the original document image.

A given document image comprises a set of entities comprising one or more entities. An entity is a piece of information that operator(s) of the present technology would like to extract and store in a structured manner such as in a relational database in the database 230. A given entity is a key: value information for a given task. The entity may be any kind or type of information such as a name, an address, a postal code, an age, a brand or make, a product model, etc. The given entity may correspond to a field.

In the context of the present technology, document images are associated with tasks. A task may be defined based on a set of entity keys, where each entity key is associated with an entity type. The entity type may include one or more of: text, number, Boolean, and the like. In one or more embodiments, the task definition may further include a respective entity formatting and respective entity validation associated with each entity key. The respective entity formatting and respective entity validation may be chosen from a list based on the entity and may include standard formatting corrections, as well as typo-fixing such as converting “0” characters into “o” in a word.

In one or more embodiments, a task definition further includes a task validation criteria, such as a validation criteria that may include more than one field.

In one or more embodiments, the tasks may be determined by operators and users of the present technology, and may be modified and determined while performing the various procedures described herein below.

In one or more embodiments, the database 230 stores templates. A template is a given visual layout for a given set of entity keys. As a non-limiting example, a template may comprise entity keys and indications of their respective locations in a document.

The database 230 stores training parameters and hyperparameters of the set of ML models 250. It will be appreciated that the type and number of training parameters and hyperparameters depend on how each of the set of ML models 250 is implemented.

In one or more embodiments, the database 230 stores a training dataset comprising a plurality of training examples with labels for training one or more the set of ML models 250. A training example may include at least a portion of a document image or its respective features. The training example may be associated with one or more labels for the text boxes, entity keys and values, etc. depending on the ML models to train.

It will be appreciated that the nature of the labelled training dataset and the number of training data is not limited and depends on the task at hand. The training dataset may comprise any kind of digital file which may be processed by a machine learning model to generate predictions as described herein.

In one or more embodiments, the database 230 may store ML file formats, such as .tfrecords, .csv, .npy, and .petastorm as well as the file formats used to store models, such as .pb and .pkl. The database 230 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

Communication Network

In one or more embodiments of the present technology, the communications network 240 is the Internet. In one or more alternative non-limiting embodiments, the communication network 240 may be implemented as any suitable local area network (LAN), wide area network (WAN), a private communication network or the like. It will be appreciated that implementations for the communication network 240 are for illustration purposes only. How a communication link 245 (not separately numbered) between the client device 210, the server 220, the database 230, and/or another electronic device (not shown) and the communications network 240 is implemented will depend inter alia on how each electronic device is implemented.

The communication network 240 may be used in order to transmit data packets amongst the client device 210, the server 220, and the database 230. For example, the communication network 240 may be used to transmit requests from the server 220 to the database 230. In another example, the communication network 240 may be used to transmit from the client device 210 to the server 220.

Text Detection and Recommendation

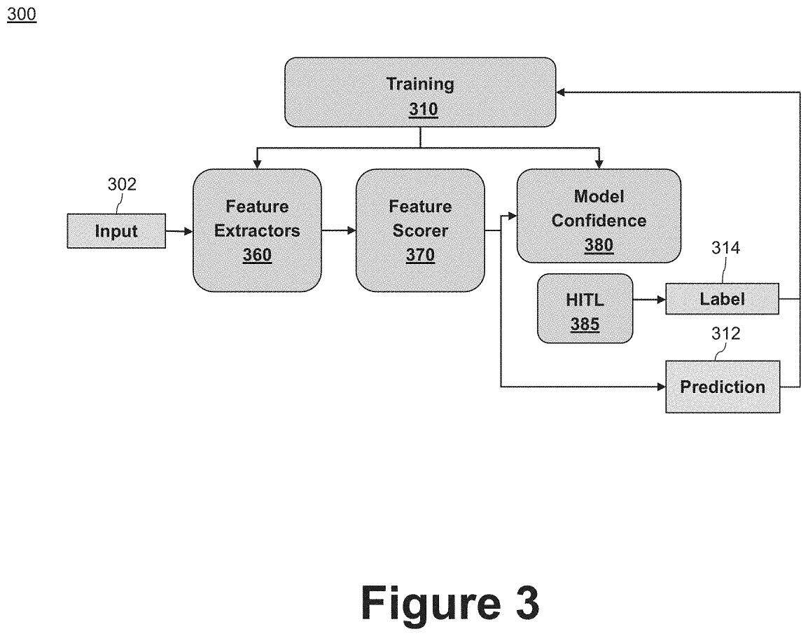

With reference to FIG. 3, there is shown a high level schematic diagram of a text detection and recommendation procedure 300 in accordance with one or more non-limiting embodiments of the present technology.

In one or more embodiments of the present technology, the server 220 executes the text detection and recommendation procedure 300. In alternative embodiments, the server 220 may execute at least a portion of the text detection and recommendation procedure 300, and one or more other servers (not shown) may execute other portions of the text detection and recommendation procedure 300.

The text detection and recommendation procedure 300 is implemented as a recommendation system for textboxes, where for a given text box in a recognized document image (e.g. a form), the goal is to predict if the given textbox (entity value) is the correct value for a field (entity key). The text detection and recommendation procedure 300 is used to extract entity values from a document image and continuously learn, via interactions with the user 205, to predict and recommend the right values for a field which may not appear explicitly in the document image. As a non-limiting example, the text detection and recommendation procedure 300 may be used to recognize that a header in a document image of a letter includes values corresponding to name, address, postal code which may be used for suggesting the values to the user 205 when completing another type of form requiring the values for the fields. As another non-limiting example, the text detection and recommendation procedure 300 can be used to recommend business codes (e.g. insurance business activity codes) based on historical data and the number of digits appearing.

In one or more embodiments, the text detection and recommendation procedure 300 is implemented as part of a visual interface displayed to the user 205 where the user 205 may provide document images for recognition and fill entity fields with recommendations provided by the present procedure. As a non-limiting example, the interface may be accessible by using a browser application on the client device 210.

The text detection and recommendation procedure 300 comprises a feature extractor 360, a scorer 370, a model confidence scorer 380, and a continuous training procedure 310 using data provided by a human in the loop (HITL) procedure 385.

The feature extractor 360, the feature scorer 370 and the model confidence scorer 380 are implemented by using the set of ML models 250.

The text detection and recommendation procedure 300 receives as an input 302 a field and at least one textbox. In one or more embodiments, the input 302 may further comprise additional information such as all other (neighboring) textboxes from OCR, additional metadata like image dimensions, and file types. Additionally or alternatively, the input 302 may comprise a document image on which to perform OCR and a field.

In one or more embodiments, the input 302 comprises characters typed so far by the user 205 for the field.

The feature extractor 360 is a feature extraction model that is configured to receive the input 302 comprising the field and the textbox and extract a set of features therefrom. The set of features comprise inter alia text features and location features of the text box.

The feature scorer 370 is a classification model that is configured to receive the set of features extracted by the feature extractor 360 and output a score based on the set of features. The feature scorer 370 determines a score for the set of features which is indicative of at least a text portion of the text box being suitable for filling the field received as an input 302. The feature scorer 370 is continuously trained to learn which feature to consider for different types of fields.

If the score is determined to be sufficient (e.g. based on thresholds or as a highest score), the feature scorer 370 may output the prediction 312, which may comprise at least a portion of the given text box. The prediction 312 may be transmitted to the model confidence scorer 380.

If the score is not considered to be sufficient for the field (e.g. based on thresholds) the prediction 312 may be provided for labelling to the HITL procedure 285.

The model confidence scorer 380 is configured to determine a confidence score for the prediction 312 output by the feature scorer 370. In one or more embodiments, the confidence score is the probability of the prediction output by the feature scorer 370 being the right one for the field. The prediction 312 may be provided to the user 205 by matching one or more characters typed by the user 205 for the field, and/or before the user 205 enters any characters for the field.

In one or more embodiments, the model confidence scorer 380 is implemented using one of the set of classification ML models 280 and the set of regression ML models 290.

In one or more embodiments, the confidence score determined by the model confidence scorer 380 may be used to prefill, recommend, and autofill the fields with values.

The HITL procedure 385 is then used to provide the output, i.e. the prediction 312, for display on the display screen 140 of the client device 210 for validation by the user 205. In one or more embodiments, the prediction 312 may include the confidence score determined by the model confidence scorer 380 and the score determined by the feature scorer 370.

The user 205 may provide, via an input/output interface (e.g. keyboard connected to the input/output interface 150 and/or touchscreen 190) of the client device 210, an indication that the prediction 312 is right or wrong.

In one or more embodiments, an indication of a right prediction may be provided by the user 205 by selecting the prediction 312 when entering data in the input field 302. An indication of a wrong prediction 312 may be provided by the user 205 by not selecting the prediction 312 and/or by entering data that is different from the prediction 312, thus providing the actual label 314 for the input field 302.

It will be appreciated that different techniques may be used to determine if the prediction 312 is accurate and/or if the prediction 312 matches the actual label 314.

In case of a wrong prediction 312, the user 205 may provide the actual label 314 for the output, which may be used by the continuous training procedure 310 to continuously train one or more of the feature extractor 360, the feature scorer 370 and the model confidence scorer 380 to perform predictions.

It will be appreciated that in some instances, the actual label 314 may not be present in the text boxes received as an input by the text detection and recommendation procedure 300.

Autocompletion

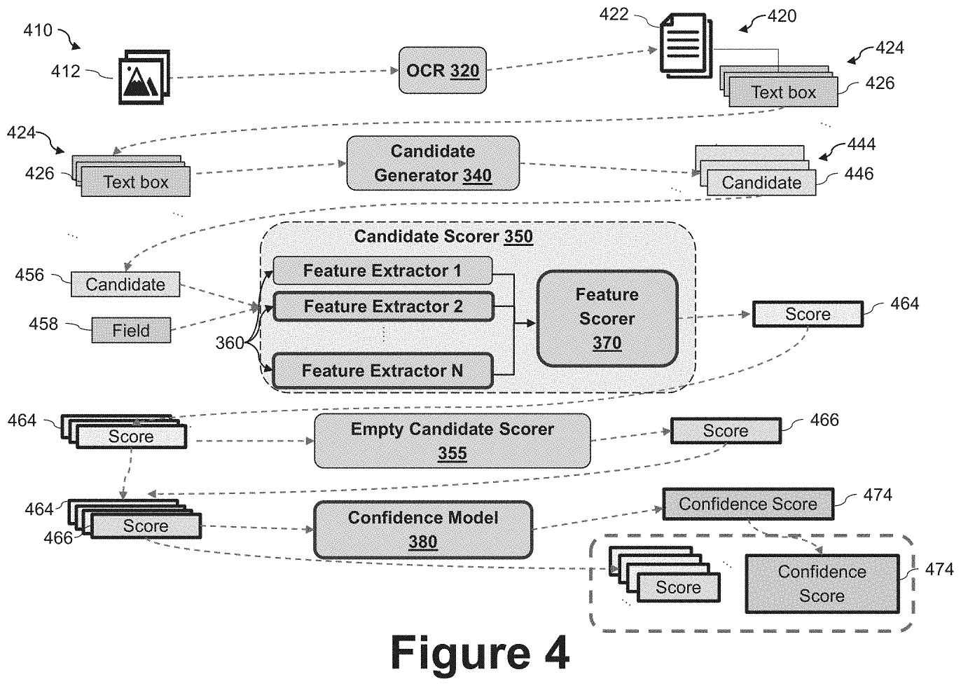

Now turning to FIG. 4, there is shown a schematic diagram of an implementation of an autocompletion procedure 400 in accordance with one or more non-limiting embodiments of the present technology.

The autocompletion procedure 400 is an implementation of the text detection and recommendation procedure 300 of FIG. 3. The autocompletion procedure 400 is used to predict the rest of the value when a user such as the user 205 types the characters in a field.

In one or more embodiments of the present technology, the server 220 executes the autocompletion procedure 400. In alternative embodiments, the server 220 may execute at least a portion of the autocompletion procedure 400, and one or more other servers (not shown) may execute other portions of the autocompletion procedure 400.

The autocompletion procedure 400 comprises inter alia an OCR procedure 320, a candidate generator 340, a candidate scorer 350 including an empty candidate scorer 355, and model confidence scorer 380.

Optical Character Recognition (OCR) Procedure

The OCR procedure 320 is configured to inter alia: (i) receive a set of document images 410, the set of images being associated with a task; and (ii) perform OCR on each document image 412 to output a recognized document 422, each recognized document 422 comprising a set of text boxes 424.

The OCR procedure 320 receives a set of document images 410 which comprises one or more document images. The OCR procedure 320 may receive the set of document images 410 from the database 230 or from another electronic device over the communication network 240. A given document image 412 may include one or more pages.

The purpose of the OCR procedure 320 is to extract entity values from the document image 412. A given document image 412 comprises a set of entities including one or more entities. An entity is a piece of information that operator(s) of the present technology would like to extract and store in a structured manner such as a relational database system. A given entity is a key: value information for a given task. The entity may be any kind or type of information such as a name, an address, a postal code, an age, a brand or make, a product model, etc.

In one or more embodiments, the set of document images 410 may be provided and/or selected by the user 205 via the client device 210. Additionally, the user 205 may provide an indication of a template (i.e. visual layout) together with the set of document images 410. It will be appreciated that the OCR procedure 320 may provide predetermined templates to the user 205 (e.g. as part of a list), who may select an appropriate template if it applies to the set of document images 410.

The OCR procedure 320 accesses the set of OCR models 260 to perform OCR of the set of documents images 410.

It will be appreciated that the set of OCR models 260 may be executed by the server 220 or may be executed by another electronic device, and the OCR procedure 320 may provide the set of document images 410 as inputs and receive outputs over the communication network 240. Non-limiting examples of OCR models include Tesseract OCR, pdf2text, and the like.

The OCR procedure 320 outputs for each document image 412 in the set of document images 410, a recognized document 422, the recognized document 422 comprising a set of text boxes 424.

The set of text boxes 424 comprises one or more textboxes 246. Each text box 426 comprises a sequence of characters (not shown) and a bounding box (not shown) indicative of coordinates of the sequence of characters in the recognized document image 412. In one or more embodiments, the OCR procedure 320 uses an OCR model comprising a localization model or localizer (not shown) to localize the bounding boxes, and recognizer or recognition model (not shown) to recognize sequence of characters in the bounding boxes.

A given sequence of characters comprises one or more characters, and may include one or more numbers, letters, words, sentences, etc. As a non-limiting example, the given text sequence may comprise “John Doe””, “222”, “m”, “Baker Street”, “London”.

The bounding box is indicative of a location of the given text sequence in the image. In one or more embodiments, the bounding box comprises an indication of height and width of a rectangle comprising the character sequence in pixels and its coordinates in the image. It will be appreciated that the recognized document 422 may further include information indicative of a structure or spatial layout of the recognized document.

The OCR procedure 320 outputs the set of recognized documents 420 for the task.

Candidate Generator

The candidate generator 340 is configured to inter alia: (i) receive the set of recognized documents 420 for the task, each recognized document 422 comprising the set of text boxes 424; and (ii) generate, using the set of text boxes 424, a set of text candidates 444.

The purpose of the candidate generator 340 is to obtain candidates that will be used for recommendation to the user 205 for one or more fields, where the goal is to ensure that values that the user 205 wants to be extracted from the recognized document 422 are part of the candidates output by the candidate generator 340.

The candidate generator 340 receives the set of recognized documents 420 output by the OCR procedure 320. In one or more other embodiments, the candidate generator 340 receives the set of recognized documents 420 from the database 230. Each recognized document 422 is associated with a set of text boxes 424. It will be appreciated that the candidate generator 340 may receive the set of text boxes 424 without receiving the given document image 412.

The candidate generator 340 generates, for each text box 426 in the set of text boxes 424, at least one respective text candidate 446.

In one or more embodiments, the candidate generator 340 splits each sequence of characters in a text box 426 into one or more words. The candidate generator 340 generates different combinations of the one or more words in the text sequence.

In one or more embodiments, the candidate generator 340 generates n-grams for the one or more words in the text box 426. The candidate generator 340 applies a sliding window of size n to generate the n-grams and obtain text candidates for the text box 426.

As a non-limiting example, for n-grams of size n=3, candidates generated include individual words, candidate created from two words next to each other merged together and candidate created from two words next to each other merged together e.g., “John Doe Jr.” may be a sequence of characters in a text box, and text candidates may include “John” “Doe”, “Jr”, “John Doe”, “Doe Jr”, “John Doe Jr”.

In one or more embodiments, when generating the combination of one or more words in a text sequence, the candidate generator 340 processes each text sequence to remove punctuations or other types of characters therefrom.

In one or more embodiments, the candidate generator 340 outputs, for each recognized document 422, a set of text candidates 444.

It will be appreciated that the candidate generator 340 may store, for each recognized document 422 of the set of recognized documents 420, the set of text candidates 444.

Candidate Scorer

The candidate scorer 350 is configured to inter alia: (i) receive an indication of a field 458; (ii) receive a given text candidate 456; (iii) generate, using the set of shared feature extractors 360, a set of candidate feature vectors (not shown) for the given text candidate 456; and (iv) determine, using the feature scorer 370, based on the set of candidate feature vectors, a candidate score 464 for the field 458.

It will be appreciated that the candidate scorer 350 may be configured to perform the above described procedures for a plurality of fields and text candidates sequentially or in parallel to thereby obtain, for each field, a set of relevant text candidates and select the top text candidate as suggestion for a field based on the candidate score 464.

In one or more embodiments, the candidate scorer 350 comprises an empty candidate scorer 355, which will be described in more detail herein below.

The candidate scorer 350 receives an indication of one or more fields 458 associated with the task. It will be appreciated that the indication of the field may comprise a field identifier (ID) associated with the field and/or the field itself.

The purpose of the candidate scorer 350 is to determine a candidate score for a given text candidate 456, the score being indicative of the given text candidate 456 being the right candidate for the field 458. It will be appreciated that the field 458 may not be present in the recognized document (e.g. a postal code “X0X 0X0” (entity value) may be present in a given text box 426 in the recognized document 422 without the expression “postal code” (entity) being present in the recognized document 322), and the candidate scorer 350 may learn that “X0X 0X0” must be recommended for the postal code field.

The candidate scorer 350 comprises a set of shared feature extractors 360 and a feature scorer 370.

The set of shared feature extractors 360 comprise one or more feature extractors 360 which have been trained to extract text candidate features for one or more fields. It will be appreciated that a different feature extractor from the set of shared feature extractors 360 may be used for a given field, or a single feature extractor from the set of shared feature extractors 360 may be used for a plurality of fields. Thus, the number of feature extractors is not limited and may comprise one, two, three or more feature extractors.

Each feature extractor in the set of shared feature extractors 360 is configured to extract, from a given text candidate 456, a respective set of candidate features. Each respective set of candidate features may be represented as an example by a respective feature vector.

In one or more embodiments, depending on the candidate 456, only a portion of the set of shared feature extractors 360 (i.e. at least one) may be used to generate a feature vector, while the remainder of the set of shared feature extractors 360 may not extract features. It will be appreciated that each feature extractor (not numbered) may extract different types of features from a candidate, however it is contemplated at least some of the features extracted by the set of shared feature extractors 360 for a given candidate may be similar.

In one or more embodiments, the set of candidate features include string statistics such as character length, number of punctuation and alphanumeric characters probability of matching a pattern e.g. if it matches a date or address pattern, and the like. One or more of the set of shared feature extractors 360 may search the nearby neighbors of each text candidate and output whether there is a match in a lookup table as a feature.

The set of candidate features may include one or more of: a text length of the text of the given text candidate 456, coordinates of the bounding box of the given text candidate 456, does the text of the given text candidate 456 match a given regular expression (REGEX) (0 or 1), has the text of the text candidate 456 already been used for that field id (0 or 1), what is the probability, given the history of text candidates for this given field id, of each of the 3-gram of the text of the text candidate 456 to be part of the value.

In one or more embodiments, the set of shared feature extractors 360 may comprise word embedding models to generate embeddings of the text candidates. Non-limiting examples of word embedding models include word2vec, GloVe, and fastText.

In one or more embodiments, the set of shared feature extractors 360 outputs a set of feature vectors (not shown) for the given text candidate 456, which are used to generate an aggregated feature vector (not shown).

In one or more embodiments, the candidate scorer 350 concatenates the set of feature vectors to obtain an aggregated feature vector for the given text candidate 456.

In one or more other embodiments, the candidate scorer 350 averages the set of feature vectors to obtain an aggregated feature vector for the given text candidate 456.

It will be appreciated that in some embodiments of the present technology, the set of feature vectors may include only one feature vector, for example when only one of the set of shared feature extractors 360 generates a feature vector for the given text candidate 456.

The feature scorer 370 receives as an input the aggregated candidate feature vector for the given text candidate 456. The feature scorer 370 receives as an input the indication of the field 458. In one or more embodiments, the feature scorer 370 receives characters typed so far by the user 205.

The feature scorer 370 comprises one or more of the set of classification ML models 280 having been trained to score text candidates based on the field 458 and feature vectors output by the set of shared feature extractors 360.

In one or more embodiments, the feature scorer 370 comprises a multi-class classifier. In one or more other embodiments, the feature scorer 370 may use a binary classifier.

In one or more embodiments, the feature scorer 370 is implemented as a random forest model. In one or more other embodiments, the feature scorer 370 may be implemented as one of a logistic regression model, a gradient boosting model (e.g. XGBoost) and a multi layer perceptron.

The candidate score is indicative of a relevance of the text candidate 456 as a value for the field 458.

The feature scorer 370 determines, for each of the set of text candidates 444 based on the respective aggregated feature vector and the indication of the field, a respective candidate score to obtain a set of candidate scores for the field. Each respective candidate score is associated with a respective text candidate in the set of text candidates.

In one or more embodiments, the candidate scorer 350 comprises an empty candidate scorer 355.

Empty Candidate Scorer

In one or more embodiments, the indication of the field 458 comprises an indication of an empty field. As a non-limiting example, the empty field may be a field that is optional in a form. When there is presence of an empty field, the candidate scorer 350 must predict that none of the input text candidates are the right ones, and that the field must remain empty. The empty candidate scorer 355 is used to create an “empty candidate” which is scored by using the scores of the other candidates. The empty candidate scorer outputs an empty candidate score 466.

In one or more embodiments, the empty candidate scorer 355 is implemented as a heuristic that yields a high score when the scores of the other candidates are low, and a low score when the scores of the other candidates are high. It is contemplated that the heuristic may be learned using ML models such that if the score of the empty candidate is higher than the scores of the other candidates, then it will be considered to be the top prediction. The top prediction will be ignored when auto-completing, but will be used to pre-fill the fields.

In one or more embodiments, the empty candidate scorer 355 computes (1-score) of all the text candidates and multiplies them together. The output is the empty candidate score 466 which includes a probability of having an empty candidate for the field 458.

The candidate scorer 350 outputs the text candidate having the highest candidate score 464 for the field 458.

Model Confidence Scorer

The model confidence scorer 380 is configured to determine a model confidence score which is a probability that the top prediction output by the candidate scorer 350, i.e. the text candidate associated with the highest candidate score 464, is the right one for the field 458.

In one or more embodiments, the model confidence scorer 380 is configured to determine the confidence score only for the top text candidate, i.e. the candidate having the highest candidate score or the best prediction. In one or more other embodiments, the model confidence scorer 380 may be configured to determine a confidence score for more than one top text candidate.

It will be appreciated that when performing straight through processing (STP), if a field is associated with a confidence score of 90%, the maximum error that may be introduced is 10% (i.e. accuracy of 90%)

The model confidence scorer 380 is configured to determine model confidence as a lower bound on the probability that the first prediction of the candidate scorer 350 is correct, i.e. if the model's best prediction is selected, what is the minimum accuracy that can be assumed?

In one or more embodiments, the model confidence scorer 380 is implemented according to two confidence thresholds per field: a first confidence threshold T₁ and a second confidence threshold T₂. Based on the confidence thresholds, the predicted values may be prefilled and transmitted to the user 205 for review and may be automatically filled without requiring review by the user 205.

The first confidence threshold may be a “smartly” defined threshold. The first confidence threshold may be determined based on statistical analysis during training of the candidate scorer 350 for example. The confidence threshold may be determined by evaluating model performance in two areas: volume (e.g., at the confidence threshold level, will a sample get autofilled or not? Once aggregated, this provides an indication of the fraction of samples that will be processed in autofill) and accuracy (e.g., at the confidence threshold level, if the sample is processed, is the prediction accurate? Once aggregated, this provides information about a fraction of autofilled samples that were correct).

The second confidence threshold may be a user-defined threshold. The second threshold is above the first confidence threshold.

If the confidence score is below the first confidence threshold and the second confidence threshold, the candidate scorer 350 may be in “teaching” mode so as to train one or more of the set of ML models 250 to perform recommendations.

If the confidence score is between the first confidence threshold and the second confidence threshold, the candidate scorer 350 is in “review” mode where the fields of the documents are shown to the user 205 along side the ones that still need teaching and are prepopulated. The HITL procedure 285 of FIG. 3 is used to obtain labelled data from the user 205.

If the confidence score is above the second threshold, the model may act automatically to autofill the fields without providing suggestions for confirmation to the user 205. It will be appreciated that if the confidence scores of all candidates in a document are above the second threshold, straight through processing (STP) may be performed without requiring confirmation from the user 205.

In one or more alternative embodiments, the distribution of the confidence scores may be found empirically for both right and wrong predicted values, which can be used to determine the second confidence threshold for performing STP. In such cases, the second confidence threshold would enable determining the exact number of errors and calculating acceptable error rate based on the number of false positives divided by the sum of true positives and false positives. It will be appreciated that such thresholds may not work for some type of distributions, for example in cases where data varies a lot such as mixed-language documents, large number of document templates and low-resource settings, the confidence threshold may be difficult to determine.

Similarly, the first confidence threshold to pre-fill the value (i.e. review mode) may be determined by finding the threshold that best separates the right/wrong values, such that the pre-filled value may be modified only 50% of the time.

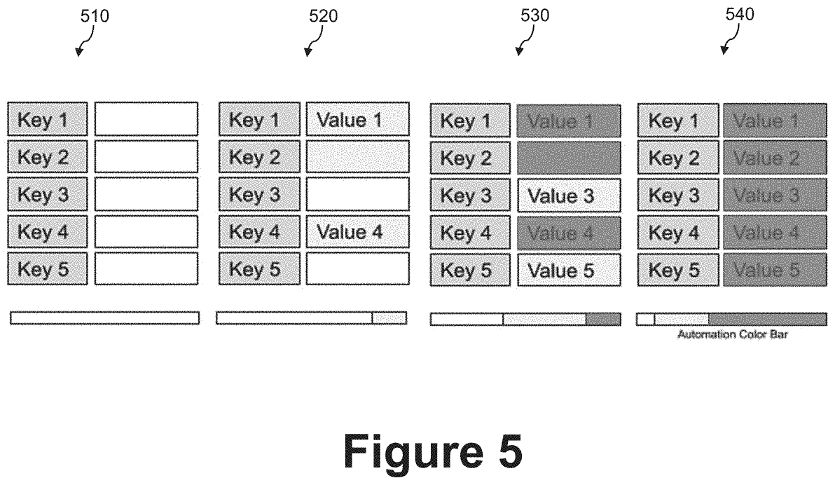

With reference to FIG. 5, there is depicted a schematic diagram of four different phases 500 of the autocompletion procedure 400 in accordance with one or more non-limiting embodiments of the present technology.

The four different phases 500 comprise a first phase 510, a second phase 520, a third phase 530 and a fourth phase 540 each depicting the autocompletion procedure 400 at different moments in time.

At the first phase 510, the set of keys and associated values, i.e. fields, are filled manually by the user 205 and used to train the candidate scorer 350.

At the second phase 520, with the confidence score above the first confidence threshold the autocompletion procedure 400 is in review mode and a portion of the fields are prepopulated with values, which enables determining the second confidence threshold. An indication explaining the prepopulation of the fields is provided via the client device 210 to the user 205 for review. The candidate scorer 350 is further trained.

At the third phase 530, predicted values for a portion of the fields have a confidence score above the first threshold, which are prepopulated with the predicted values and shown to the user 205 for review. Another portion of the fields have values predicted by the candidate scorer 350 with the confidence score being above the second confidence threshold, and may be safely ignored by the user 205 because the error will be no more than the second confidence threshold. The candidate scorer 350 is further trained.

At the fourth phase 540, the candidate scorer 350 has learned to populate the fields with a confidence score that is above the second confidence threshold, and is in straight through processing (STP) mode, thus not requiring confirmation from the user 205. Prior to executing the STP mode, an indication may be provided to the user 205 that STP mode may be activated upon confirmation.

Method Description

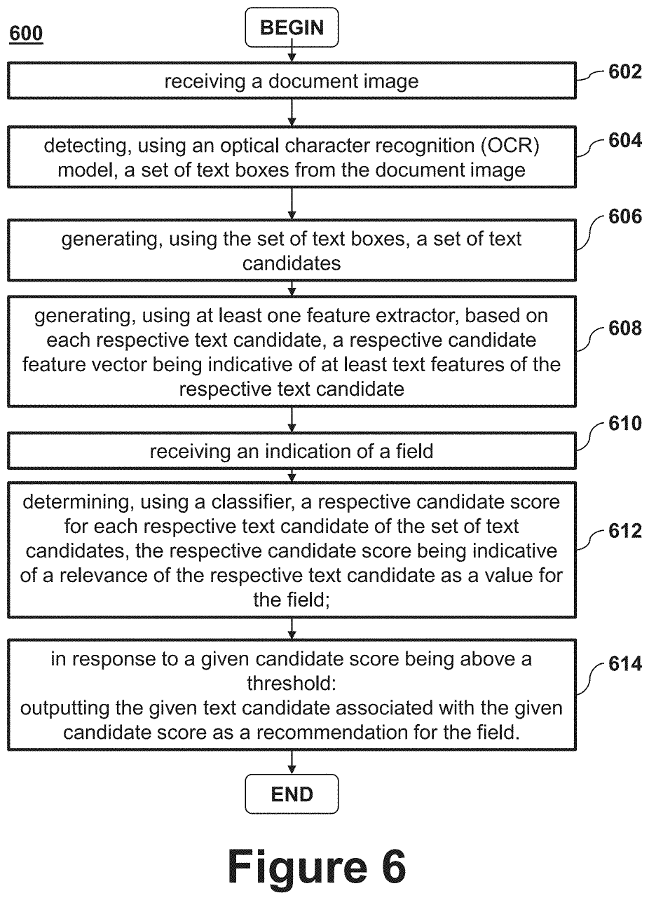

FIG. 6 depicts a flowchart of a method 600 for predicting a value for a given field using information extracted from a document after performing optical character recognition (OCR), the method 600 being depicted in accordance with one or more non-limiting embodiments of the present technology.

In one or more embodiments, the server 220 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the method 600.

The method 600 begins at processing step 602.

According to processing step 602, the processing device receives a document image 412. In one or more embodiments, the processing device receives the document image 412 from the database 230 or from the client device 210 over the communication network 240. The document image 412 comprises sequences of characters organized in a structured or semi-structured manner.

According to processing step 604, the processing device detects, using an OCR model of the set of OCR models 260, a set of text boxes 424 in the document image 412. In one or more embodiments, the set of text boxes 424 each comprise a text sequence and a bounding box. The set of text boxes 424 may be overlayed on the document image 412 to obtain a recognized document 422.

According to processing step 606, the processing device generates, using the set of text boxes 424, a set of text candidates 444.

The processing device generates the respective text candidates for the text box 426 based on combinations of words in the text box 426.

In one or more embodiments, the processing device generates n-grams for the one or more words in the text box 426 by applying a sliding window of size n to generate the n-grams and obtain text candidates for the text box 426.

In one or more embodiments, the processing device processes each text sequence to remove punctuations or other types of characters therefrom.

According to processing step 608, the processing device generates, using the set of shared feature extractors 360, for each given text candidate 456, a respective candidate feature vector comprising a set of candidate features indicative of at least text features of the given text candidate 456.

In one or more embodiments, the set of candidate features include string statistics as features (character length, number of punctuation and alphanumeric characters, probability of matching a pattern e.g. if it matches a date or address pattern). The set of shared feature extractors 30 may search the nearby neighbors of each candidate and output whether there is a match in a lookup table as a feature.

The set of candidate features may include one or more of: a text length of the text of the given text candidate 456, coordinates of the bounding box of the given text candidate 456, does the text of the given text candidate 456 match a given regular expression (REGEX) (0 or 1), has the text of the text candidate 456 already been used for that field id (0 or 1), what is the probability, given the history of text candidates for this given field id, of each of

In one or more embodiments, the set of shared feature extractors 360 outputs a set of feature vectors for the given text candidate 456, which are combined to generate an aggregated feature vector. In one or more other embodiments, the set of candidate feature vectors comprises only one candidate feature vector.

According to processing step 610, the processing device receives an indication of a field 458. The indication of the field 458 may be associated with a task. It will be appreciated that the indication of the field may comprise a field identifier (ID) associated with the field and/or the field itself.

The indication of the field 458 may for example be an indication of a field to be filled with value by the user 205, and where the value may be present in the set of text boxes 424.

In one or more embodiments, the processing device receives one or more characters typed by the user 205 and associated with the indication of the field 458.

In one or more embodiments, processing step 610 may be executed prior to processing step 608 or in parallel with processing step 608.

According to processing step 612, the processing device determines, by using one of the set of classification ML models 280, for each given text candidate 456, based on the candidate feature vector and the indication of the field 458, a respective candidate score 464. The respective candidate score 464 is indicative of a relevance of the given text candidate 456 as a value for the field 458.

In one or more embodiments, the processing device uses a model confidence scorer 380 to determine a confidence score for the given text candidate 456. The confidence score is indicative of the probability of the prediction output by the set of classification ML models 280 being the right one for the field 458.

According to processing step 614, in response to a respective candidate score 464 being above a threshold, the processing device outputs the given text candidate associated with the respective candidate score as a prediction for the field 458.

In one or more embodiments, processing step 614 is executed in response to the confidence score output by the model confidence scorer 380 is above a threshold.

The method 600 then ends.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

1. A method for recommending a given text candidate as a value for a field, the method being executed by a processor, the method comprising:
receiving a document image;
detecting, using an optical character recognition (OCR) model, a set of text boxes from the document image, each text box of the set of text boxes comprising a respective character sequence;
generating, for each text box in the set of text boxes, based on at least the respective character sequence, at least one respective text candidate to thereby obtain a set of text candidates;
generating, using at least one feature extractor, based on each respective text candidate, a respective candidate feature vector being indicative of at least text features of the respective text candidate;
receiving an indication of the field;
determining, using a classifier, based on the respective candidate feature vector, a respective candidate score for each respective text candidate of the set of text candidates, the respective candidate score being indicative of a relevance of the respective text candidate as a value for the field; and
in response to a given candidate score being above a threshold:
outputting the given text candidate associated with the given candidate score as a recommendation for the field.

2. The method of claim 1, further comprising, after said determining the respective candidate score:
determining, using a confidence model, a respective confidence score being indicative of a probability of the given text candidate being an exact match for the field; and wherein
said outputting the given text candidate associated with the given candidate score as the recommendation for the field is further based on the respective confidence score being above a confidence threshold.

3. The method of claim 2, wherein
the confidence threshold is a first confidence threshold; and wherein
the method further comprises, in response to the given candidate score being above a second confidence threshold:
filing the field with the given text candidate.

4. The method of claim 1, wherein
the processor is connected to a client device; wherein
said receiving the indication of the field is received from the client device; and wherein
said outputting the given text candidate associated with the given candidate score as the recommendation for the field comprises transmitting, for display on a display interface of the client device, the given text candidate.

5. The method of claim 1, wherein
each text box of the set of text boxes is associated with a respective bounding box indicative of a location of the text box in the document image; and wherein
said generating, for each text box in the set of text boxes, at least one respective text candidate to thereby obtain a set of text candidates is further based on the respective bounding box.

6. The method of claim 1, wherein said receiving the indication of the field comprises receiving an indication of at least one character typed by a user for the field.

7. The method of claim 1, wherein
the at least one feature extractor comprises a plurality of feature extractors; and wherein
said generating the candidate feature vector for the respective text candidate comprises generating, using the plurality of feature extractors, a respective set of feature vectors and combining the respective feature vectors to obtain the candidate feature vector.

8. The method of claim 1, wherein
said receiving the indication of the field is performed prior to said generating, using the at least one feature extractor, based on each respective text candidate, the respective candidate feature vector; and wherein
said generating, using the at least one feature extractor, based on each respective text candidate, the respective candidate feature vector is further based on the indication of the field.

9. The method of claim 1, wherein the candidate feature vector comprises at least one of: string statistics of the text candidate, an indication if the text candidate matches a given predetermined regular expression (REGEX), an indication if the text candidate has been previously used for a given field, an indication of a probability given past candidates for a given field for the given text candidate to be part of the value of the field.

10. The method of claim 1, wherein said generating the text candidate comprises:
splitting the given text box into a set of words; and
generating n-grams from the set of words to thereby obtain the text candidate.

11. The method of claim 1, further comprising, in response to none of the respective candidate scores being above the threshold:
transmitting an indication to label the field;
receiving the label for the field; and
training the classifier based on the field and the label for the field.

12. The method of claim 1, wherein the classifier comprises a random forest model.

13. A system for recommending a given text candidate as a value for a field, the system comprising:
a processor; and
a non-transitory storage medium comprising instructions,
the processor, upon executing the instructions, being configured for:
receiving a document image;
detecting, using an optical character recognition (OCR) model, a set of text boxes from the document image, each text box of the set of text boxes comprising a respective character sequence;
generating, for each text box in the set of text boxes, based on at least the respective character sequence, at least one respective text candidate to thereby obtain a set of text candidates;
generating, using at least one feature extractor, based on each respective text candidate, a respective candidate feature vector being indicative of at least text features of the respective text candidate;
receiving an indication of the field;
determining, using a classifier, based on the respective candidate feature vector, a respective candidate score for each respective text candidate of the set of text candidates, the respective candidate score being indicative of a relevance of the respective text candidate as a value for the field; and
wherein the processor is further configured for, in response to a given candidate score being above a threshold:
outputting the given text candidate associated with the given candidate score as a recommendation for the field.

14. The system of claim 13, wherein the processor is further configured for, after said determining the respective candidate score:
determining, using a confidence model, a respective confidence score being indicative of a probability of the given text candidate being an exact match for the field; and wherein
said outputting the given text candidate associated with the given candidate score as the recommendation for the field is further based on the respective confidence score being above a confidence threshold.

15. The system of claim 14, wherein
the confidence threshold is a first confidence threshold; and wherein
the processor is further configured for, in response to the given candidate score being above a second confidence threshold:
filing the field with the given text candidate.

16. The system of claim 13, wherein
the processor is connected to a client device; wherein
said receiving the indication of the field is received from the client device; and wherein
said outputting the given text candidate associated with the given candidate score as the recommendation for the field comprises transmitting, for display on a display interface of the client device, the given text candidate.

17. The system of claim 13, wherein
each text box of the set of text boxes is associated with a respective bounding box indicative of a location of the text box in the document image; and wherein
said generating, for each text box in the set of text boxes, at least one respective text candidate to thereby obtain a set of text candidates is further based on the respective bounding box.

18. The system of claim 13, wherein said receiving the indication of the field comprises receiving an indication of at least one character typed by a user for the field.

19. The system of claim 13, wherein
the at least one feature extractor comprises a plurality of feature extractors; and wherein
said generating the candidate feature vector for the respective text candidate comprises generating, using the plurality of feature extractors, a respective set of feature vectors and combining the respective feature vectors to obtain the candidate feature vector.

20. The system of claim 13, wherein
said receiving the indication of the field is performed prior to said generating, using the at least one feature extractor, based on each respective text candidate, the respective candidate feature vector; and wherein
said generating, using the at least one feature extractor, based on each respective text candidate, the respective candidate feature vector is further based on the indication of the field.

21. The system of claim 13, wherein the candidate feature vector comprises at least one of: string statistics of the text candidate, an indication if the text candidate matches a given predetermined regular expression (REGEX), an indication if the text candidate has been previously used for a given field, an indication of a probability given past candidates for a given field for the given text candidate to be part of the value of the field.

22. The system of claim 13, wherein said generating the text candidate comprises:
splitting the given text box into a set of words; and
generating n-grams from the set of words to thereby obtain the text candidate.

23. The system of claim 13, wherein the processor is further configured for, in response to none of the respective candidate scores being above the threshold:
transmitting an indication to label the field;
receiving the label for the field; and
training the classifier based on the field and the label for the field.

24. The system of claim 13, wherein the classifier comprises a random forest model.
